(19) United States
(12) Patent Application Publication
(10) Pub. No.: US 2017/0010173 A1
(43) Pub. Date: Jan. 12, 2017

(54) PANORAMIC KNOCK SENSOR SYSTEMS AND METHODS FOR ENGINE COMPONENT HEALTH DETECTION

(71) Applicant: General Electric Company, Schenectady, NY (US)

(72) Inventor: Jeffrey Jacob Bizub, Milwaukee, WI (US)

(21) Appl. No.: 14/796,934

(22) Filed: Jul. 10, 2015

(51) Int. Cl. G01L 23/22; F02D 41/14

(52) U.S. Cl. CPC G01L 23/221; F02D 41/1497

(57) ABSTRACT

A system includes an engine control system configured to receive a first vibration signal from a first knock sensor disposed about a reciprocating engine, apply a binaural model to the first vibration signal, derive an engine health condition based on the application of the binaural model to the first vibration signal, and communicate the engine health condition.

### BACKGROUND

The subject matter disclosed herein relates to knock sensors, and more specifically, to panoramic knock sensor systems and methods applied to component health detection.

Engines, such as combustion engines, will typically combust a carbonaceous fuel, such as natural gas, gasoline, diesel, and the like, and use the corresponding expansion of high temperature and pressure gases to apply a force to certain components of the engine, e.g., piston disposed in a cylinder, to move the components over a distance. Each cylinder may include one or move valves that open and close correlative with combustion of the carbonaceous fuel. For example, an intake valve may direct an oxidizer such as air into the cylinder, which is then mixed with fuel and combusted. Combustion fluids, e.g., hot gases, may then be directed to exit the cylinder via an exhaust valve. Accordingly, the carbonaceous fuel is transformed into mechanical motion, useful in driving a load. For example, the load may be a generator that produces electric power. Unfortunately, combustion engines include a large number of moving parts that have a possibility of wearing down. In certain situations, it is beneficial to locate and identify a health of the engine or engine components.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes an engine control system configured to receive a first vibration signal from a first knock sensor disposed about a reciprocating engine, apply a binaural model to the first vibration signal, derive an engine health condition based on the application of the binaural model to the first vibration signal, and communicate the engine health condition.

In a second embodiment, a method includes receiving a first vibration signal from a first knock sensor disposed about a reciprocating engine, applying a binaural model to the first vibration signal, deriving an engine health condition based on the application of the binaural model to the first vibration signal, and communicating the engine health condition.

In a third embodiment, a system includes computer program product being embodied in a non-transitory computer readable storage medium and comprising computer-executable instructions for: receiving a first vibration signal from a first knock sensor disposed about a reciprocating engine, applying a binaural model to the first vibration signal, deriving an engine health condition based on the application of the binaural model to the first vibration signal, and communicating the engine health condition.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a portion of an engine driven power generation system in accordance with aspects of the present disclosure;

FIG. 2 is a side cross-sectional view of an embodiment of a piston assembly within a cylinder of the reciprocating engine shown in FIG. 1 in accordance with aspects of the present disclosure;

FIG. 3 is a side cross-sectional view of an embodiment of a process suitable for creating a virtual lambda sensor model for the internal combustion engine of FIG. 2; and

FIG. 4 is an embodiment of a process 110 that may be performed by the ECU 25 of FIG. 3.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The techniques described herein include combining signals from a plurality of knock sensors, e.g., panoramic knock sensors, to jointly develop a binaural signal that provides improved diagnostic representation of one or more cylinders within a combustion engine. The signals detected by the plurality of knock sensors may be correlated to crankangles of the engine (e.g., reciprocating engine). By matching signals to crankangles of the one or more cylinders, multiple knock sensor signals may be evaluated together to determine a more accurate location for anomalies in the operation of the engine. By sampling several sensors simultaneously in small time windowed snapshots (e.g., similar to a camera operating at high shutter speed) and by using multiple sensors and snapshots (e.g., similar to a panoramic photo), a binaural audio signature can be obtained. Indeed, when obtained with two sensors spatially separated from each other, the binaural signature may provide improved detection of engine and/or engine component health. The binaural audio signature may vary in “shape” of the signature when specific mechanical failures occur. The techniques described herein provide for binaural-ambiophonic modeling and recording via noise or vibration sensors, such as knock sensors, to determine the vibrational characteristic of an engine system or component. Binaural methods may advantageously just use two sensors, but it is to be noted that more may be used. Accordingly, engine wear characteristics of the engine and components may be determined, suitable for detecting engine issues and improving maintenance.

The signals may be compared to other signals from “healthy” engines to determine whether the current operation of the combustion engine is also healthy. For example, the signals may be compared to past signals from the same combustion engine, or from other combustion engines in the same model to determine whether the combustion engine is healthy or whether there could be an issue within the combustion engine that should be addressed.

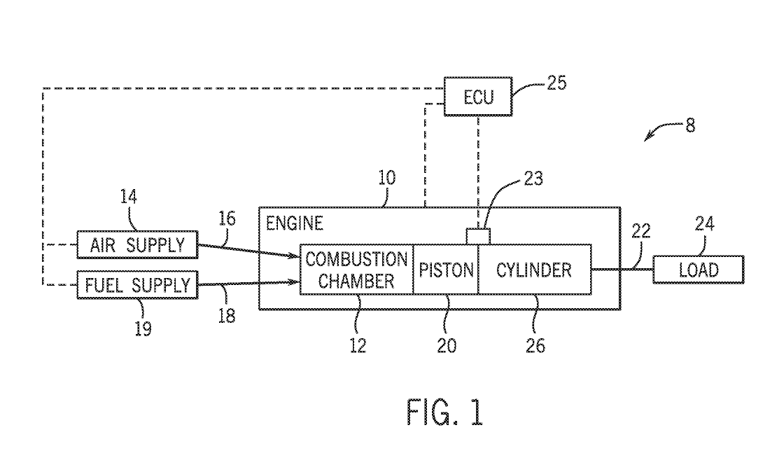

Turning to the drawings, FIG. 1 illustrates a block diagram of an embodiment of a portion of an engine driven power generation system 8. As described in detail below, the system 8 includes an engine 10 (e.g., a reciprocating internal combustion engine) having one or more combustion chambers 12 (e.g., 1, 2, 3, 4, 5, 6, 7, 8, 10, 12, 14, 16, 18, 20, or more combustion chambers 12). An air supply 14 is configured to provide an oxidant 16, such as air, oxygen, oxygen-enriched air, oxygen-reduced air, or any combination thereof, to each combustion chamber 12. The combustion chamber 12 is also configured to receive a fuel 18 (e.g., a liquid and/or gaseous fuel) from a fuel supply 19, and a fuel-air mixture ignites and combusts within each combustion chamber 12. The hot pressurized combustion gases cause a piston 20 adjacent to each combustion chamber 12 to move linearly within a cylinder 26 and convert pressure exerted by the gases into a rotating motion, which causes a shaft 22 to rotate. Further, the shaft 22 may be coupled to a load 24, which is powered via rotation of the shaft 22. For example, the load 24 may be any suitable device that may generate power via the rotational output of the system 10, such as an electrical generator. Additionally, although the following discussion refers to air as the oxidant 16, any suitable oxidant may be used with the disclosed embodiments. Similarly, the fuel 18 may be any suitable gaseous fuel, such as natural gas, associated petroleum gas, propane, biogas, sewage gas, landfill gas, coal mine gas, for example.

The system 8 disclosed herein may be adapted for use in stationary applications (e.g., in industrial power generating engines) or in mobile applications (e.g., in cars or aircraft). The engine 10 may be a two-stroke engine, three-stroke engine, four-stroke engine, five-stroke engine, six-stroke engine, or more. The engine 10 may also include any number of combustion chambers 12, pistons 20, and associated cylinders (e.g., 1-24). For example, in certain embodiments, the system 8 may include a large-scale industrial reciprocating engine having 4, 6, 8, 10, 16, 24 or more pistons 20 reciprocating in cylinders. In some such cases, the cylinders and/or the pistons 20 may have a diameter of between approximately 13.5-34 centimeters (cm). In some embodiments, the cylinders and/or the pistons 20 may have a diameter of between approximately 10-40 cm, 15-25 cm, or about 15 cm. The system 10 may generate power ranging from 10 kW to 10 MW. In some embodiments, the engine 10 may operate at less than approximately 1800 revolutions per minute (RPM). In some embodiments, the engine 10 may operate at less than approximately 2000 RPM, 1900 RPM, 1700 RPM, 1600 RPM, 1500 RPM, 1400 RPM, 1300 RPM, 1200 RPM, 1000 RPM, 900 RPM, or 750 RPM. In some embodiments, the engine 10 may operate between approximately 750-2000 RPM, 900-1800 RPM, or 1000-1600 RPM. In some embodiments, the engine 10 may operate at approximately 1800 RPM, 1500 RPM, 1200 RPM, 1000 RPM, or 900 RPM. Exemplary engines 10 may include General Electric Company's Jenbacher Engines (e.g., Jenbacher Type 2, Type 3, Type 4, Type 6 or J920 FleXtra) or Waukesha Engines (e.g., Waukesha VGF, VHP, APG, 275GL), for example.

The driven power generation system 8 may include one or more knock sensors 23 suitable for detecting engine “knock.” The knock sensor 23 may sense vibrations caused by the engine, such as vibration due to detonation, pre-ignition, and/or pinging. The knock sensor 23 is shown communicatively coupled to an engine control unit (ECU) 25. During operations, signals from the knock sensor 23 are communicated to the ECU 25 to determine if knocking conditions (e.g., pinging) exist. The ECU 25 may then adjust certain engine 10 parameters to ameliorate or eliminate the knocking conditions. For example, the ECU 25 may adjust ignition timing and/or adjust boost pressure to eliminate the knocking. As further described herein, the knock sensor 23 may additionally derive that certain vibrations should be further analyzed and categorized to detect, for example, undesired engine conditions. Also further described herein, the ECU 25 may receive signals from a plurality of knock sensors 23 to triangulate a location for certain engine conditions. For example, binaural techniques such as binaural-ambiophonic modeling and recording techniques may be applied to a plurality of the knock sensors 23 to derive engine 10 and engine components health assessments, as described in more detail below.

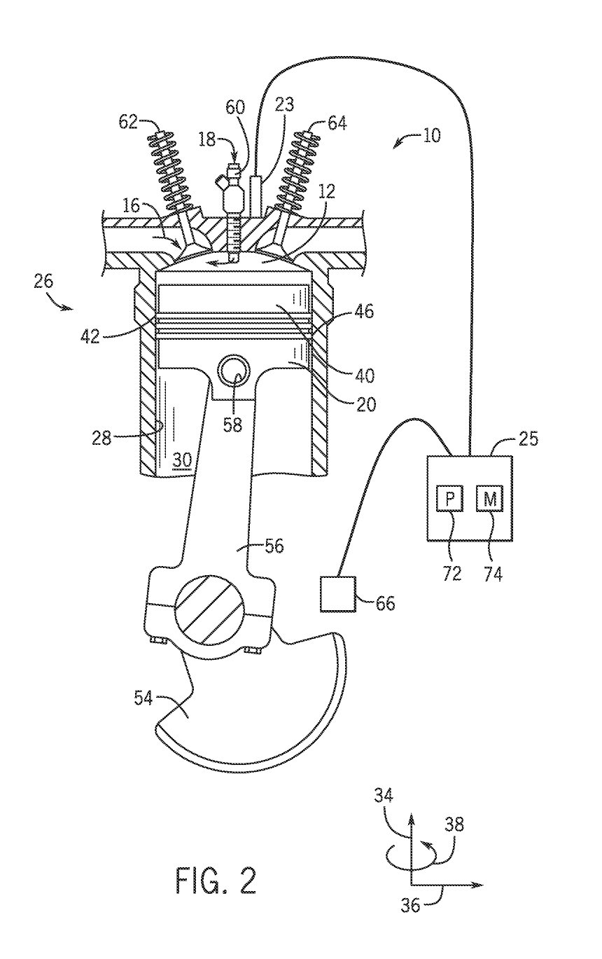

FIG. 2 is a side cross-sectional view of an embodiment of a piston assembly 25 having a piston 20 disposed within a cylinder 26 (e.g., an engine cylinder) of the reciprocating engine 10. The cylinder 26 has an inner annular wall 28 defining a cylindrical cavity 30 (e.g., bore). The piston 20 may be defined by an axial axis or direction 34, a radial axis or direction 36, and a circumferential axis or direction 38. The piston 20 includes a top portion 40 (e.g., a top land). The top portion 40 generally blocks the fuel 18 and the air 16, or a fuel-air mixture 32, from escaping from the combustion chamber 12 during reciprocating motion of the piston 20.

As shown, the piston 20 is attached to a crankshaft 54 via a connecting rod 56 and a pin 58. The crankshaft 54 translates the reciprocating linear motion of the piston 20 into a rotating motion. As the piston 20 moves, the crankshaft 54 rotates to power the load 24 (shown in FIG. 1), as discussed above. As shown, the combustion chamber 12 is positioned adjacent to the top land 40 of the piston 20. A fuel injector 60 provides the fuel 18 to the combustion chamber 12, and an intake valve 62 controls the delivery of air 16 to the combustion chamber 12. An exhaust valve 64 controls discharge of exhaust from the engine 10. However, it should be understood that any suitable elements and/or techniques for providing fuel 18 and air 16 to the combustion chamber 12 and/or for discharging exhaust may be utilized, and in some embodiments, no fuel injection is used. In operation, combustion of the fuel 18 with the air 16 in the combustion chamber 12 cause the piston 20 to move in a reciprocating manner (e.g., back and forth) in the axial direction 34 within the cavity 30 of the cylinder 26.

During operations, when the piston 20 is at the highest point in the cylinder 26 it is in a position called top dead center (TDC). When the piston 20 is at its lowest point in the cylinder 26, it is in a position called bottom dead center (BDC). As the piston 20 moves from top to bottom or from bottom to top, the crankshaft 54 rotates one half of a revolution. Each movement of the piston 20 from top to bottom or from bottom to top is called a stroke, and engine 10 embodiments may include two-stroke engines, three-stroke engines, four-stroke engines, five-stroke engine, six-stroke engines, or more.

During engine 10 operations, a sequence including an intake process, a compression process, a power process, and an exhaust process typically occurs. The intake process enables a combustible mixture, such as fuel and air, to be pulled into the cylinder 26, thus the intake valve 62 is open and the exhaust valve 64 is closed. The compression process compresses the combustible mixture into a smaller space, so both the intake valve 62 and the exhaust valve 64 are closed. The power process ignites the compressed fuel-air mixture, which may include a spark ignition through a spark plug system, and/or a compression ignition through compression heat. The resulting pressure from combustion then forces the piston 20 to BDC. The exhaust process typically returns the piston 20 to TDC while keeping the exhaust valve 64 open. The exhaust process thus expels the spent fuel-air mixture through the exhaust valve 64. It is to be noted that more than one intake valve 62 and exhaust valve 64 may be used per cylinder 26.

The depicted engine 10 also includes a crankshaft sensor 66, the knock sensor 23, and the engine control unit (ECU) 25, which includes a processor 72 and memory 74. The crankshaft sensor 66 senses the position and/or rotational speed of the crankshaft 54. Accordingly, a crank angle or crank timing information may be derived. That is, when monitoring combustion engines, timing is frequently expressed in terms of crankshaft 54 angle. For example, a full cycle of a four stroke engine 10 may be measured as a 720° cycle. The knock sensor 23 may be a Piezo-electric accelerometer, a microelectromechanical system (MEMS) sensor, a Hall effect sensor, and/or any other sensor designed to sense vibration, acceleration, sound, and/or movement.

Because of the percussive nature of the engine 10, the knock sensor 23 may be capable of detecting signatures even when mounted on the exterior of the cylinder 26. However, the knock sensor 23 may be disposed at various locations in or about the cylinder 26. Additionally, in some embodiments, a single knock sensor 23 may be shared, for example, with one or more adjacent cylinders 26. In other embodiments, each cylinder 26 may include one or more knock sensors 23. The crankshaft sensor 66 and the knock sensor 23 are shown in electronic communication with the engine control unit (ECU) 25. The ECU 25 includes a processor 72 and a memory 74. The memory 74 may store computer instructions that may be executed by the processor 72. The ECU 25 monitors and controls and operation of the engine 10, for example, by adjusting combustion timing, valve 62, 64, timing, adjusting the delivery of fuel and oxidant (e.g., air), and so on.

Advantageously, the techniques described herein may use the ECU 25 to receive data from the crankshaft sensor 66 and the knock sensor 23, and then to creates a “noise” signature by plotting the knock sensor 23 data against the crankshaft 54 position. Multiple knock sensor 23 signals may be used to create one or more binaural models, such as binaural-ambiophonic models of engine operations. Accordingly, spatial information may be provided, in addition to noise signature information. The ECU 25 may then go through the process of analyzing the data to derive normal (e.g., known and expected noises) and abnormal signatures (e.g., unknown or unexpected noises), and noise location. The ECU 25 may then characterize the abnormal signatures, as described in more detail below. By providing for signature analysis, the techniques described herein may enable a more optimal and a more efficient operations and maintenance of the engine 10.

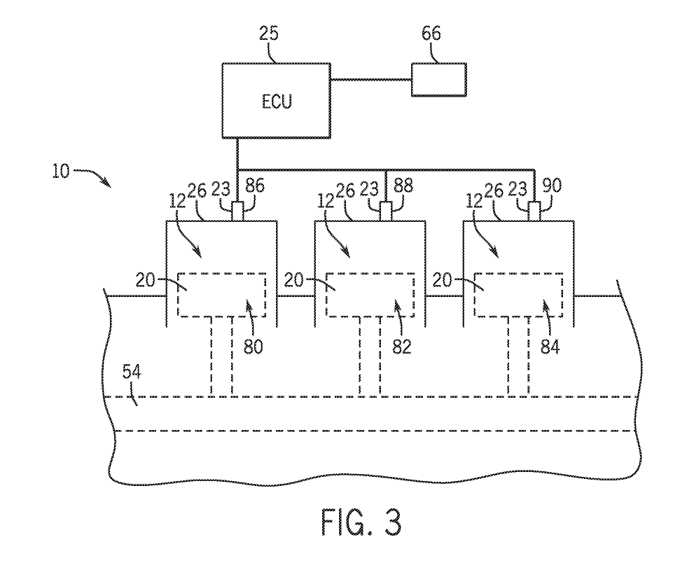

FIG. 3 is a diagrammatical perspective view of an embodiment of the engine of FIG. 1 having multiple combustion chambers 12, pistons 20, and cylinders 26. As mentioned above, the engine 10 may include any number of cylinders 26, but in FIG. 3, only three are shown. The illustrated embodiment thus shows a first cylinder 80, a second cylinder 82 and a third cylinder 84. The first cylinder 80 includes a first knock sensor 86 that detects knock (e.g., pinging) in a location proximate to the first cylinder 80. The second cylinder 82 has a corresponding second knock sensor 88, and the third cylinder 84 has a corresponding third knock sensor 90. Each knock sensor 23 may constantly monitor for vibrations and send the signal back to the ECU 25. The ECU 25 receives the signals and aggregates the signals from all knock sensors 23 to derive a binaural signature for the engine 10 as a whole. For example, signals from two sensors 23 may be aggregated using binaural techniques to define one or more binaural signatures. The signatures may define the location for certain signals and, by extension, determine locations for engine parts generating the sounds. The signatures may be stored as a panoramic snapshot of a healthy-running engine 10.

The ECU 25 may perform analysis such a Fast-Fourier transforms, wavelet/joint time-frequency analysis, etc. on the signals received from the knock sensors 23 in order to aggregate the signals together in discrete ranges as illustrated in the following chart.

| Knock | | | | |
|---|---|---|---|---|
| Sensor | Crankangle | Crankangle | Crankangle | Crankangle |
| 1 | 0-15 cycle 1 | 15-30 cycle 1 | 690-705 cycle 1 | 705-720 cycle 1 |
| 1 | 0-15 cycle 2 | 15-30 cycle 2 | 690-705 cycle 2 | 705-720 cycle 2 |
| 1 | 0-15 cycle 3 | 15-30 cycle 3 | 690-705 cycle 3 | 705-720 cycle 3 |
| 1 | 0-15 cycle 4 | 15-30 cycle 4 | 690-705 cycle 4 | 705-720 cycle 4 |
| 1 | . . . | . . . | . . . | . . . |
| 1 | 0-15 cycle N | 15-30 cycle N | 690-705 cycle N | 705-720 cycle N |
| 2 | 0-15 cycle 1 | 15-30 cycle 1 | 690-705 cycle 1 | 705-720 cycle 1 |
| 2 | 0-15 cycle 2 | 15-30 cycle 2 | 690-705 cycle 2 | 705-720 cycle 2 |
| 2 | 0-15 cycle 3 | 15-30 cycle 3 | 690-705 cycle 3 | 705-720 cycle 3 |
| 2 | 0-15 cycle 4 | 15-30 cycle 4 | 690-705 cycle 4 | 705-720 cycle 4 |
| 2 | . . . | . . . | . . . | . . . |
| 2 | 0-15 cycle N | 15-30 cycle N | 690-705 cycle N | 705-720 cycle N |

The chart above may be generated by the ECU 25 of FIG. 3 based on an analysis of the received data from the knock sensors 23, and may subsequently be used to binaurally model the location of healthy and abnormal operation of the engine 10. That is, to provide a time-dependent element to the signals received from multiple knock sensors 23, each cell in the chart includes a frequency signature for the signal from the particular knock sensor 23 for the given crankangle range. For example, the ECU 25 may receive the knock signal from the first knock sensor 86 and the second knock sensor 88 for a number of cycles. The ECU 25 may record several cycles (e.g., N cycles) or may continuously record the data until the data is manually reset. The cycles, as illustrated in the chart, may include 720 crankangle degrees before starting the cycle over. The ECU 25 may also record a cycle of 180, 360, 540, 720, 900, or more, degrees per cycle. The ECU 25 may break-up the signal from the knock sensors 23 based on the crankangle signal from the crankangle sensor 66. In the illustrated embodiment, the signal from each knock sensor 23 is broken up into discrete crankangle ranges of 15 degrees. A first crankangle range includes the signal from all knock sensors 23 when the crankshaft 54 rotates from 0 to 15 degrees. A second crankangle range includes the signal from all knock sensors 23 when the crankshaft 54 rotates from 15 to 30 degrees, and so on. The ECU 25 may then use binaural modeling to compare frequency signatures for each of the knock sensors 23.

The binaural modeling may indicate that an abnormal signal is occurring at a specific time (crankangle range) during operation of the engine 10. Each crankangle range corresponds to a condition/position of the associated cylinder/piston that is being monitored. For example, the first crankangle range may correspond to the beginning of combustion for the first cylinder 80, while the second crankangle range 18 may correspond to combustion of another cylinder, or some other event. The ECU 25 may associate these events with the received signals to develop a signature for each combination of crankangle range and knock sensor 23. That is, the ECU 25 may develop a binaural (multi-aural) signature across all knock sensors 23 at a specific crankangle range to determine a comprehensive health and/or normal operating condition for the entire engine 10. The signature represents the basic signal that is expected from each knock sensor 23. The ECU 25 stores a default signature and compares the default to the currently received signal each cycle 128. For normal operation, each respective signature 124, 126 may be expected to be consistent from a first cycle to a second cycle and so on. If the signature 124, 126 varies from one cycle to the next, the ECU 25 may trigger a notice. The notice may depend on several factors including the severity and/or the constancy of the change from the signature 124, 126, the speed at which the signature 124, 126 is changing, whether the signature 124, 126 returns to normal, etc. For example, if the signature is abnormal for several cycles but then returns to normal for several cycles, and does this consistently for a number of minutes, the ECU 25 may trigger a notice that a valve (e.g., exhaust valve 64) is stuck.

Furthermore, the ECU 25 is able to combine signals from several knock sensors 23 to binaurally indicate a specific location from which an abnormal signal may be generated. Binaural modeling for this type of signature generation develops similarly to the way that humans, for example, determine a location of a sound. For sounds directly in front or behind a person reach both ears at substantially the same time. If the sound is generated at an angle from the person's head, the sound will reach one ear before reaching the other ear. The ECU 25 may operate in a similar manner to determine a location of an abnormal signature. The binaural model that results from the modeling may be a specific range and amplitudes of frequencies registered at two or more receptors (e.g., knock sensors 23). The binaural model includes a timing component between the two or more receptors that is used to determine the angle from which a sound was generated. For example, the first knock sensor 86 may detect an abnormal signal in signature ranges 5 through 15. The ECU 25 may associate this anomaly with a condition that occurs during a particular part of the combustion cycle for the first cylinder 80. Additionally, the ECU 25 may track the signals from the other knock sensors (e.g., second knock sensor 88 and third knock sensor 90) and determine that the same or substantially similar anomalous sound signal is being read by the other knock sensors 23 during other crankangle ranges. The ECU 25 may then determine that the source for the anomalous sound is coming from a specific angle and specific distance from the knock sensors 23. If a related abnormal signal occurs in the second knock sensor 88 during crankangle ranges 7-17 and for the third knock senor 90 during crankangle ranges 9-19, then the ECU 25 may determine that the cause of the abnormal signal is located closer to the first knock sensor 86. Then, depending on the nature of the abnormal signal, the ECU 25 may trigger a notice to take a certain action.

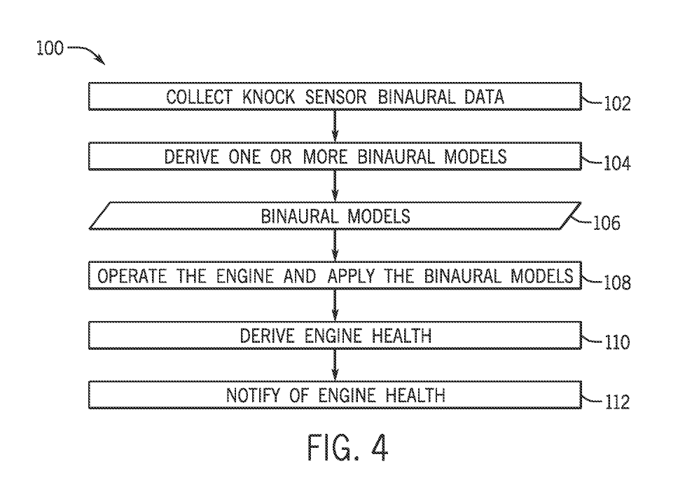

FIG. 4 is an embodiment of a process 100 that may be performed by the ECU 25 of FIG. 3. The process 100 begins with the ECU 25 collecting knock sensor binaural data from the knock sensors 23 (block 102). As explained above, the knock sensor data includes vibration information from a number of location about the engine 10. The knock sensor data is collect in discrete packets based on the sensor location and a time component. The time component may include a crankangle of the crankshaft 54. From the binaural data, the ECU 25 derives one or more binaural models for healthy operation of the engine 10 (block 104). The binaural models may be derived through ambiophonic signal processing that eliminates crosstalk between the signals from the different knock sensors 23. That is, the models combine the signals in a way similar to ambiophonic stereo systems that detect sound and are able to reproduce that sound as if a listener was positioned in a specific location relative to the sound sources. As with ambiophonic stereo, the ECU 25 derives models that “memorize” or store the location of the vibrations that are detected by the knock sensors 23. For example, combustion within the second cylinder 82 may register as a certain frequency signature on each of the first knock sensor 86, second knock sensor 88, and third knock sensor 90. The models store the frequency signatures and the temporal relationships between the frequency signatures so that the operation of the second cylinder 82 can accurately be monitored. Binaural models may be created for a number of different operating parameters. For example, the ECU 25 may include a binaural model for startup of the engine 10, full load operation, partial load operation (e.g., operation at one or more load levels, fuel flow levels, torque levels, and so on), or shut down. As may be appreciated, the models may include similar frequency signatures for each of the knock sensors 23 for the different operation times, but also may include different frequency signatures and thus provide additional diagnosis options for the ECU 25. The models may be derived by an ECU 25 that is connected to an operational engine 10, or may be derived and stored by an external system (e.g., computer, server, cloud-based system, smart phone, tablet, laptop) that is connected to an engine 10 at a central location such as a lab or a testing facility (block 106). The models may then be transferred to the ECU 25 and stored within the memory 74.

Once the models are stored within the ECU 25 (either self-recorded or through transfer), the ECU 25 operates the engine 10 and applies the binaural models (block 108). As mentioned above, the ECU 25 may operate the engine and apply the models during any stage of operation. Applying the models includes detecting the current signal from the knock sensors 23 and comparing the vibration signals to the models stored within the ECU 25. If the detected signals do not match the model stored for the operation cycle and/or crankshaft angle, then the ECU 25 is able to detect a location for the different signal. Through application of the binaural model, the ECU 25 is able to derive the health of the engine 10 and/or determine the part or parts of the engine 10 that may be causing the mismatched signal (block 110). For example, if the detected signal aberration is detected to have come from the intake valve 62, the ECU 25 may derive that the intake valve 62 is sticking, or otherwise may benefit from inspection. The ECU 25 may, in such an instance, notify of the engine health (block 112). Notification may include sending a signal to an operator, or in some instances changing the operation of the engine 10. For example, the ECU 25 may derive that the engine 10 needs to be shut down in which case the ECU 25 may be programmed to automatically shut down the engine 10.

Technical effects of the disclosed embodiments include engine control units (ECU) 25 that operate reciprocating engines and derive health of the engine 10 and its components through application of models stored on the ECU 25. The models include analysis of frequency signals from knock sensors 23 about the engine 10. During operation of the engine 10, the ECU 25 compares signals from the knock sensors 23 to the models stored within the ECU 25. Based on the comparison and application of the models, the ECU 25 can determine a location of vibrations that do not match the stored model, which enables the ECU 25 to derive current health of specific components of the engine 10. The ECU 25 may then provide notification with a specific recommendation for repairing/replacing the component.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system comprising:
an engine control system configured to:
receive a first vibration signal from a first knock sensor disposed about a reciprocating engine;
apply a binaural model to the first vibration signal;
derive an engine health condition based on the application of the binaural model to the first vibration signal; and
communicate the engine health condition.

2. The system of claim 1, wherein the binaural models comprise a time component.

3. The system of claim 2, wherein the time component comprises a crankangle of the reciprocating engine.

4. The system of claim 1, wherein engine control system is configured to receive a second vibration signal from a second knock sensor disposed about the reciprocating engine.

5. The system of claim 4, wherein the controller is configured to apply the binaural model to a combination of the first vibration signal and the second vibration signal to locate a source of the first vibration signal and the second vibration signal.

6. The system of claim 5, wherein the first vibration signal is received by the first knock sensor at a first crankangle range and the second vibration signal is received by the second knock sensor at a second crankangle range.

7. The system of claim 4, wherein the controller is configured to apply the binaural model to a concurrent combination of the first vibration signal and the second vibration signal to determine a comprehensive health of the reciprocating engine.

8. The system of claim 1, wherein deriving the engine health condition comprises detecting a severity, a constancy, or any combination thereof between the applied binaural model and the first vibration signal.

9. A method, comprising
receiving a first vibration signal from a first knock sensor disposed about a reciprocating engine;
applying a binaural model to the first vibration signal;
deriving an engine health condition based on the application of the binaural model to the first vibration signal; and
communicating the engine health condition.

10. The method of claim 9, comprising transforming the first vibration signal into a frequency signature before applying the binaural model.

11. The method of claim 10, wherein transforming the first vibration signal comprises dividing the first vibration signal into discrete time segments.

12. The method of claim 11, wherein the time segments are based on a crankangle range of the reciprocating engine.

13. The method of claim 12, wherein the crankangle range comprises a range of 15 degrees.

14. The method of claim 9, comprising receiving a second vibration signal from a second knock sensor disposed about the reciprocating engine.

15. The method of claim 14, comprising applying the binaural model to a combination of the first vibration signal and the second vibration signal to locate a source of the first vibration signal and the second vibration signal.

16. The method of claim 9, wherein deriving the engine health condition comprises deriving a severity or a constancy of the first vibration signal after applying the binaural model.

17. A computer program product being embodied in a non-transitory computer readable storage medium and comprising computer-executable instructions for:
receiving a first vibration signal from a first knock sensor disposed about a reciprocating engine;
applying a binaural model to the first vibration signal;
deriving an engine health condition based on the application of the binaural model to the first vibration signal; and
communicating the engine health condition.

18. The computer program product of claim 17, wherein the instructions comprise instructions for receiving a second vibration signal from a second knock sensor disposed about the reciprocating engine, and locating a source of the first vibration signal and the second vibration signal.

19. The computer program product of claim 18, wherein deriving the engine health condition comprises deriving a location of an abnormal vibration within the reciprocating engine.

20. The computer program product of claim 17, wherein the instructions comprise instructions for automatically adjusting operating parameters based on the engine health condition.
